(19) United States
(12) Patent Application Publication
(10) Pub. No.: US 2008/0230940 A1
(43) Pub. Date: Sep. 25, 2008

(54) Method For Producing Metal-Ceramic-Composite Materials

(75) Inventors: Gerd Meier, Leinburg (DE); Ilka Lenke, Plochingen (DE)

Correspondence Address: FULBRIGHT & JAWORSKI, LLP, 666 FIFTH AVE, NEW YORK, NY, 10103-3198, US

(73) Assignee: CERAMTEC AG INNOVATIVE CERAMIC ENGINEERING, Plochingen (DE)

(21) Appl. No.: 11/596,512

(22) PCT Filed: May 12, 2005
(86) PCT No.: PCT/EP05/05171

§ 371 Date: Dec. 7, 2006

(30) Foreign Application Priority Data
May 19, 2004 (DE) 10 2004 025 342.0
Apr. 26, 2005 (DE) 10 2005-019 662.4

(51) Int. Cl. B29C 43/52

(52) U.S. Cl. 264/122

(57) ABSTRACT

The production of moulded bodies from hard-metal powders by pressing and simultaneous or subsequent heat treatment is known. The mixture of hard material powders and aluminium powders for producing dry-pressed moulded bodies is an example thereof. As a result of the risk of demixing and the loss of homogeneity, the upper limit, for example according to prior art, for the proportion of hard material particles added to the aluminium powder is approximately 20 vol. %. The aim of the invention is to increase the proportion of hard material particles it the mixture. To this end, the inventive method for producing metal ceramic composite materials is characterised by dry-pressing powders with base compositions of between 25 and 79 vol. % of at least one metallic phase, preferably aluminium and the alloys thereof, and between 75 and 21 vol. % of at least one non-metallic inorganic constitnent, as ceramic materials, preferably silicon carbides, aluminium oxides, titanium oxides, carbon and silicates.

The invention relates to the production of metal-ceramic-composite materials (MCC materials).

The known methods of production that are on the market today for metal-ceramic-composite materials are based either on the infiltration of porous precursor bodies with liquid metals, the stirring-in of particles or fibres into metallic melts, the spray-compacting of metal-ceramic mixtures, or centrifugal casting.

In the case of the infiltration method, basic ceramic materials are pressed and at temperatures between 900° C. and 1200° C. consolidated. Subsequently, the porous pressed bodies are infiltrated with metallic materials in a second, cost-intensive working step. If particles or fibres are stirred into a melt, the degree of filling is as a rule limited to a maximum of 25% by volume. What is problematic is the sedimentation of the particles in the liquid melt, giving rise to an inhomogeneous structure. Alternative methods of production, such as centrifugal casting, on account of the effect of the centrifugal force on the hard-material particles that are of differing weights, result in an inhomogeneous distribution of the latter in the workpiece. When particle-reinforced injection-moulding compounds are used, there is the risk of the formation of textures.

The production of moulded bodies from hard-metal powders by pressing and simultaneous or subsequent heat treatment is known. In the case of the production of composite materials, the material properties determine the mixture ratio. The mixture of hard-material powders and aluminium powders to produce dry-pressed moulded bodies, as is known from DE 103 06 096 A1, is an example of this. On account of the risk of demixing and the loss of homogeneity, in accordance with the prior art, for example, the upper limit for the addition of metallic hard-material particles to aluminium powder lies at approximately 20% by volume.

Metal-ceramic-composite materials having a base composition of one or more metallic phases, preferably aluminium and its alloys, in a proportion of 30 to 75% by volume and as the ceramic materials one or more non-metallic inorganic components in a proportion of 25 to 70% by volume are known from DE 103 06 096 A1. In this specification nothing is stated about the method for producing the materials.

An object of the present invention is to increase the proportion of hard-material particles in the mixture of dry-pressed moulded bodies without the occurrence of the known disadvantages.

The object is achieved by means of metal-ceramic-powder mixtures with a ceramic proportion of between 21 and 75% by volume that can be pressed by dry-pressing to form stable moulded bodies. A portion of the ceramic materials can be replaced by metallic hard materials, such as, for example, TiC, TiN, Ti(CN) and WC.

The particle size of the respective hard-material particles or ceramic particles lies below 150 μm, with D50-values preferably between 30 μm and 70 μm.

Surprisingly, as well, the high pressing powers known from powder metallurgy of, for example, 6000 bar are not required. Already with a pressing power of 2000 bar it is possible to produce dense and functioning components.

Metal-ceramic-powder mixtures are used for dry-pressing, these being characterised by base compositions consisting of one or more metallic phases, preferably aluminium and its alloys, in a proportion of 25 to 79% and as the ceramic materials, in a proportion of 75 to 21% by volume, one or more non-metallic inorganic components, preferably silicon carbides, aluminium oxides, titanium oxides, carbons and silicates, and also, if applicable, the metallic hard materials. During the pressing process or after the pressing, the compressed powder bodies are treated thermally in order to consolidate the structure and to increase the composite strength.

A preferred MCC material based on SiC and Al has a composition of 25 to 79% by volume Al and 75 to 21% by volume SiC with a thermal conductivity of, for example, 180 W/mK, a flexural strength of, for example, 200 MPa and also a modulus of elasticity of, for example, 200 GPa.

1-21. (canceled)

22. A method for producing molded bodies from metal-ceramic-composite materials, characterised in that the base compositions consist of one or more metallic phases, preferably aluminium and its alloys, in a proportion of 25 to 79% by volume, and as the ceramic materials one or more non-metallic inorganic components, preferably silicon carbides, aluminium oxides, titanium oxides, carbon and silicates, in a proportion of 75 to 21% by volume, in which case a portion of the ceramic materials of the base compositions can be replaced by metallic hard materials, such as, for example, TiC, TiN, Ti(CN) and WC, in that the grain size of the powders lies between 0.2 μm and 150 μm, in that the powders are dry-pressed at a pressing power of less than 7000 bar, preferably less than 2000 bar, and in that in order to consolidate the pressed moulded bodies subsequently heat treatment is effected at temperatures between 500° C. and 1000° C.

23. A process according to claim 22, wherein the compression of the powder occurs by means of axial compression.

24. A process according to claim 22, wherein the compression of the powder occurs by means of isostatic compression.

25. A process according to claim 22, wherein the molded bodies, even in the compression process, are subjected to a thermal treatment at temperatures of 100 to 1000° C., preferably at temperatures of 550 to 700° C.

26. A method comprising using a molded body made of a metal-ceramic composite material produced according to the process of claim 22 using soldering, welding, and friction welding with metallic materials.

27. The method of claim 26, wherein the metallic material is aluminum and its alloys.

28. A method of using a molded body made of metal-ceramic composite materials manufactured according to the process of claim 22.

29. A method comprising using a molded body made of metal-ceramic composite materials produced according to the process of claim 22 as a sliding ring, counter-ring, axial gudgeon washer, gasket, radial bearing, side plate for pumps and compressors, rotor and housing washer of vane cell and rotary cell pumps or compressors.

30. A method comprising using a molded body made of metal-ceramic composite materials manufactured according to the process of claim 22 in the field of protecting persons, motor vehicles or objects.

31. A method comprising using a molded body made of metal-ceramic composite materials manufactured according to the process of claim 22 for the purpose of sharpening knife blades and cutting and cleaving edges of corresponding cleaving tools.

32. A method comprising using a molded body made of metal-ceramic composite materials manufactured according to the process of claim 22 as a shaft and axle in radial and axial bearings.

33. A method comprising using molded body made of metal-ceramic composite materials manufactured according to the process of claim 22 in dosage, regulating and closing valves and fittings.

34. A method comprising using a molded body made of metal-ceramic composite materials manufactured according to the process of claim 22 in mills and other size-reduction devices.

35. A method comprising a molded body made of metal-ceramic composite materials manufactured according to the process of claim 22 as a guide for reversing and texturing fibers and yarns, as a yarn tensioning device, and as material for a rotor in rotor spinning in the textile industry.

36. A method comprising using a molded body made of metal-ceramic composite materials manufactured according to the process of claim 22 in drawing and reshaping wire.

37. A method comprising using a molded body made of metal-ceramic composite materials manufactured according to the process of claim 22 as components in transport technology.

38. A method comprising using a molded body made of metal-ceramic composite materials manufactured according to the process of claim 22 in the processing of work pieces and surface processing as a cutting tool and as a grinding tool.
